(19) United States
(12) Patent Application Publication
(10) Pub. No.: US 2005/0157518 A1
(43) Pub. Date: Jul. 21, 2005

(54) Small-angled, specifically-positioned and specifically-orientated light emitting device of backlight module of liquid crystal display

(76) Inventors: Miyashita Kazuhiro, Kaohsiung (TW); Yu-Ping Liu, Kaohsiung (TW); Chao-Fang Chung, Kaohsiung (TW)

Correspondence Address: PRO-TECHTOR INTERNATIONAL SERVICES, 20775 Norada Court, Saratoga, CA, 95070-3018, US

(21) Appl. No.: 10/812,574

(22) Filed: Mar. 29, 2004

(30) Foreign Application Priority Data
Jan. 20, 2004 (TW) 093101468

(51) Int. Cl. F21V 7/04

(52) U.S. Cl. 362/615

(57) ABSTRACT

The present invention of “small-angled, specifically-positioned and specifically-orientated light emitting device of backlight module of liquid crystal display” is related to LCD backlight module which emitting light beams from specified positions, with each emitted light beam limited to small angle range, and with orientations of that angle range of each emitted beam including orientation pointing to specified opening of LCD substrate or with such and vertical to emitting face of light guiding plate, and with distance of central line of neighboring emitted light beams nearing distance of neighboring LCD substrate openings, and with no light being emitted between two neighboring emitted light beams, in comparison with that conventional LCD backlight module emits light wholly, continuously and evenly from light emitting face of light guiding plate. Large amount of energy is wasted in the conventional backlight module owing to its illumination on the opaque part of LCD substrate such as common electrode and black matrix. As the present invention emits light beams from specified positions, with each beam limited to small angle and pointing to each corresponding opening of LCD substrate, energy can be used efficiently; brightness can be raised; display quality can be promoted; electricity energy consumption can be lowered down, and life of battery can be postponed.

### BACKGROUND OF THE INVENTION

1. Field of the Invention

The present invention pertains to a kind of LCD backlight module which emitting light beams nonuniformly from specified positions, with each emitted light beam limited to small angle range, and with orientations of said angle range of each emitted beam including orientation pointing to specified opening of LCD substrate or with such and vertical to emitting face of light guiding plate, and with distance of central line of neighboring emitted light beams nearing distance of neighboring LCD substrate openings, and with no light being emitted between two neighboring emitted light beams.

2. Description of Related Art

The prior arts of backlight module mainly focus on emitting light evenly; As shown in U.S. Pat. No. 6,356,391, however it is formed by prism arrays also, its aim is to get light emitting of continuous and entire evenness.

Further, as shown in U.S. Pat. No. 5,917,664, while it is formed by prism arrays also, its aim is to avoid sudden change of brightness when across certain angle during changing viewing-angle.

Technological thought of small-angled, specifically-positioned and specifically-orientated light emitting device of backlight module of liquid crystal display of the present invention is distinct from those prior arts.

As illustrated in Part 1 and Part 2 of FIG. 8, “light guiding plate having multi-focused reflecting patterns” of TAIWAN PATENT published No. 463957 has a plurality of multi-focused reflecting patterns on opposite face of emitting face of light guiding plate. Each pattern has a round surface at center, with a plurality of annular round surfaces being concentric from said round surface. Incident light is reflected, by each pattern on LGP, upwards to form plane-type light source. This prior art is that brightness of plane-type light source is made evenly distributed by multi-directioned reflection of multi-focused reflecting mirrors. Technological thought of the present invention is distinct from this prior art.

As illustrated in Part 1 and Part 2 of FIG. 9, “plane-type light source” of TAIWAN PATENT published No. 538285 utilizes multi-direction refraction of concave lenses 11n or convex lenses 11p to make emitting face near lateral incident face have enough brightness.

As illustrated in Part 1 and Part 2 of FIG. 10, and Part 1 and Part 2 of FIG. 11, this prior art also has variant distribution concentration of concave mirrors 12p or convex mirrors 12n on opposite face of LGP's emitting face and lateral faces except incident face.

By the way of multi-direction of concave and convex mirrors' reflection and higher concentration of reflecting mirrors in periphery of LGP h where brightness is apt to be insufficient, it is possible to achieve evenness of brightness and direction of emitting of plane-type light source. The technological thought of the present invention is distinct from this prior art.

As illustrated in FIG. 12, “LCD having localized-light-transmitting backlight” of TAIWAN PATENT published No. 560621 has a plurality of light passages 52 in reflecting layer 51 on the bottom of LCD f, and has a micro-prisms-arrayed optical film g possessing light-focusing portions 61 corresponding to light passages 52, between LCD f and LGP h. The artificial light L5, after being concentrated, transmits through light passages 52 in reflecting layer 51, and into LCD f. The total output comes from combined effects of highly reflected natural light L4 from reflecting layer 51 and artificial light L5 enhanced by micro-prism-arrayed optical film g, with enhanced total light output of LCD.

The stronger function of light-focusing portions 61, the more artificial light L5 transmitting through light passages 52, and the less proportion of area occupied by light passages 52, and therefore the larger proportion of area used to reflect, and then more reflected natural light L4 can be used. According to this design, light output of LCD f can be promoted, and contrast of LCD f to natural light L4 can be increased.

This prior art is characterized in reflecting layer 51 possessing light passages 52 and micro-prisms-arrayed optical film g possessing light-focusing portions 61.

Although it would make emitted artificial light L5 point to specified positions according to its claims' declaration, the critical structure of micro-prisms-arrayed optical film g possessing light-focusing portions 61 and corresponding parameters thereof are not disclosed at all.

According to specification and drawings of this prior art, its micro-prisms-arrayed optical film g is independent from LGP. The macrostructure of this prior art is different from that of the present invention which has a plurality of lower prisms engaged together with LGP and an independent upper prism plate possessing a plurality of upper prisms.

Most important of all, the present invention discloses not only its optical process, but the microstructure also, including its characteristics and its corresponding parameters.

### SUMMARY OF THE INVENTION

The aim of the present invention is to solve the problem of conventional backlight module that large amount of energy is wasted in illuminating opaque portion of LCD substrate such as common electrode and black matrix, and to provide a kind of backlight module which emits light beams nonuniformly from specified positions, with each beam limited to small angle range and pointing to specified opening of LCD substrate.

As illustrated in FIG. 1 and FIG. 2, the structure of the present invention includes:
Lower prism 1, making light beams propagating in certain angles range inside LGP transmit through its emitting face 7 of lower prism 1;
Light guiding plate 2 (LGP), engaged with a plurality of lower prisms 1 into an integral unit on its emitting surface; or produced together, with a plurality of lower prisms 1 located on its emitting surface, in an unit process;
Upper prism 3, making light beams transmitting into its entering face 8 be reflected totally from its total reflecting face 9 and transmit through upper prism plate 4 in certain specified orientations;
Upper prism plate 4, engaged with a plurality of upper prisms 3 into an integral unit; or produced together with a plurality of upper prisms 3 in an unit process.

The cross section of said lower prism 1 or said upper prism 3 includes quasi-triangle, and the descriptions and illustrations of the present invention mentioned below will take lower prism and upper prism having quasi-triangle cross section as representative examples to describe.

As illustrated in FIG. 2, the optical process of the present invention is described as follows:

The light beams propagating in certain angles range (with respect to LGP2) inside LGP2 are refracted by each lower prism 1 and transmit through emitting face 7 of each lower prism 1, and across air gap 6; then said light beams are incident on, refracted by and transmit into entering face 8 of corresponding upper prism 3, and said light beams propagate inside upper prism 3 and onto total reflecting face 9, and then said light beams are totally reflected from said total reflecting face 9, and further said totally reflected light beams transmit through upper prism plate 4.

The said light beams transmitting through upper prism plate 4 are limited to small angle range, with orientations of said small angle range including pointing to a specified orientation.

In the descriptions and illustrations of the present invention, it is taken as representative example that orientations of said small angle range include one pointing to a specified opening 5 of LCD substrate and vertical to upper prism plate 4.

The said light beams transmitting through upper prism plate 4 can be looked as if emitted from a specified corresponding position on LGP.

In the descriptions and illustrations of the present invention, it is taken as representative example that said light beams transmitting through upper prism plate 4 can be looked as if those were emitted from nearby of border 16 of each two corresponding neighboring lower prisms.

The optical process described above has the following characteristics:
(1) each light beam transmitting through upper prism plate 4 is emitted only from border's nearby of corresponding lower prisms;
(2) each light beam transmitting through upper prism plate 4 is limited to small angle range, with orientations of said small angle range include one pointing to a specified opening 5 of LCD substrate and vertical to upper prism plate 4;
(3) lines, which are drawn from borders of each two neighboring lower prisms and vertical to upper prism plate 4, will transmit through corresponding openings 5 of LCD substrate;
(4) the angle θ₁, formed by incident ray on total reflecting face 11 and normal of total reflecting face 11, is equal to or greater than critical angle θ_{c} of upper prism 3's material;
(5) width A′ of light beam transmitting through upper prism plate 4 is near width A of said light beam before leaving lower prism 1, as illustrated in FIG. 4.

To achieve the optical process described above, lower prism 1 and upper prism 3 have to possess the following characteristics and have the following relationships with LGP2, upper prism plate 4 and LCD substrate.

The following corresponding parameters are described with reference to FIG. 2 and FIG. 3:
(1) the length L of bottom side 1 of quasi-triangle of lower prism 1 (i.e. border line between lower prism 1 and LGP2) is similar to distance of neighboring openings 5 of LCD substrate;
(2) lines, which are drawn from borders 16 of each two neighboring lower prisms and vertical to upper prism plate, will transmit through corresponding openings 5 of LCD substrate;
(3) range of opposite angle ω of lower prism 1's emitting face 7 is:
   0<ω≦0.5θ_{c},
   wherein θ_{c} is critical angle of lower prism 1's material;
(4) range of angle α formed by emitting face 7 and bottom side 10 of lower prism 1 is:
   0<α≦90°;
(5) range of vertex angle θ of upper prism 3's quasi-triangle, which is near LGP 2, is:
   90°-θ_{c}≦θ≦180°-α-ω,
   wherein θ_{c} is critical angle of lower prism 1's material; α is angle formed by emitting face 7 and bottom side 10 of lower prism 1, and ω is opposite angle of lower prism 1's emitting face;
(6) range of curvature radius r₁ of upper prism 3's entering face 8 is:
   T<r₁≦∞,
   wherein T is the shortest distance between LCD reflecting layer and “intersecting point of entering face 8 of upper prism 3 and total reflecting face 9 of upper prism 3”;
(7) range of curvature radius r₂ of upper prism 3's total reflecting face is:
   T<r₂≦∞,
   wherein T is the shortest distance between LCD reflecting layer and “intersecting point of entering −face 8 of upper prism 3 and total reflecting face 9 of upper prism 3”;
(8) curvature center of entering face 8 and total reflecting face 9 of upper prism 3 are above the border 12 between upper prism 3 and upper prism plate 4 (i.e. opposite side 12 of vertex angle θ of upper prism 3's quasi-triangle).

As illustrated in FIG. 5, when there is an air layer 13, which can not be neglected, between LCD 14 and backlight module, each light beam emitted from upper prism plate 4 into air layer 13 is to have a refractive angle, resulting in that light beam width B becomes larger when reaching LCD 14's substrate. As illustrated in FIG. 6, one of methods which solving this problem is to adhere a film with similar refractive index of upper prism 3 or to apply a filling layer with similar refractive index of upper prism 3; As the refractive indexes are similar, light beam width B′ is to be smaller than B, when reaching LCD 14's substrate.

### BRIEF DESCRIPTION OF THE DRAWINGS

FIG. 1 illustrates structure of the present invention.

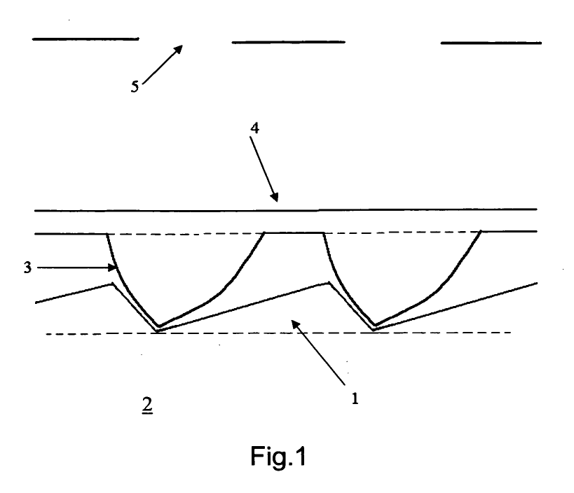

FIG. 2 illustrates optical process of the present invention.

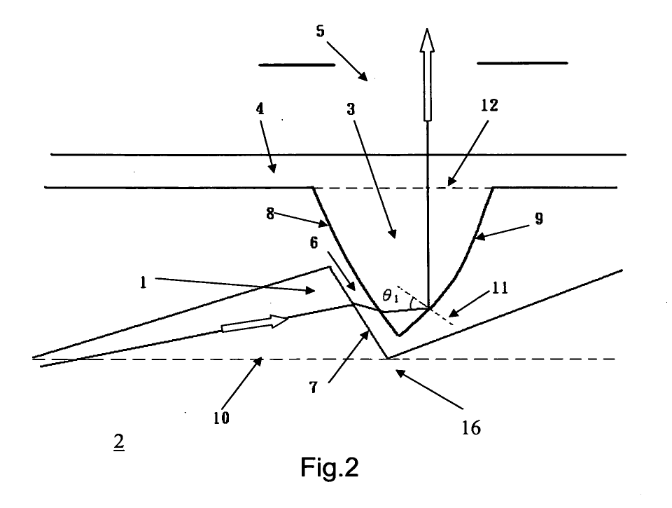

FIG. 3 illustrates parameters of the structure of the present invention.

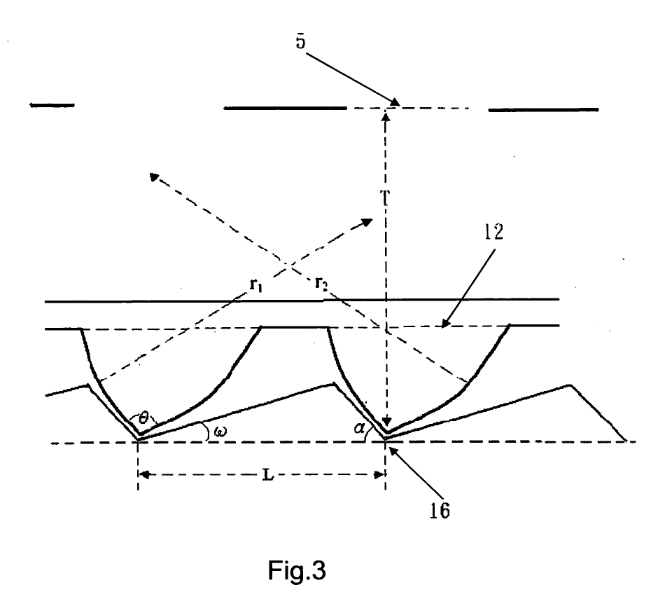

FIG. 4 illustrates small angle range of emitted light beam of the present invention.

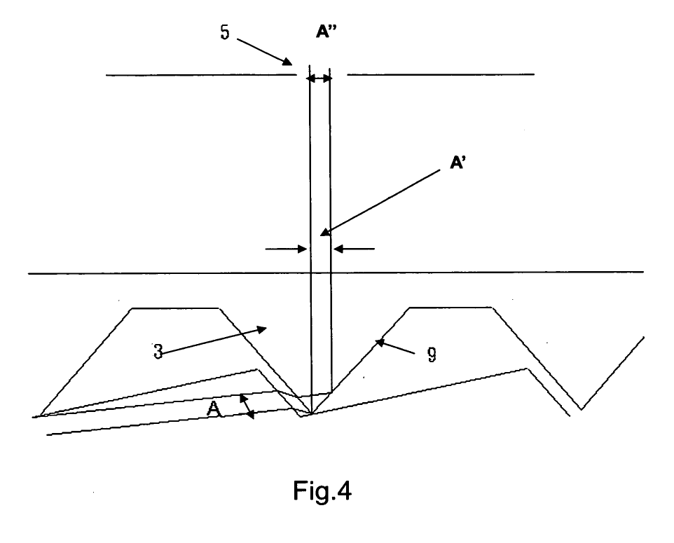

FIG. 5 illustrates effect on light beam width when reaching LCD substrate without film having similar refractive index of upper prism 3.

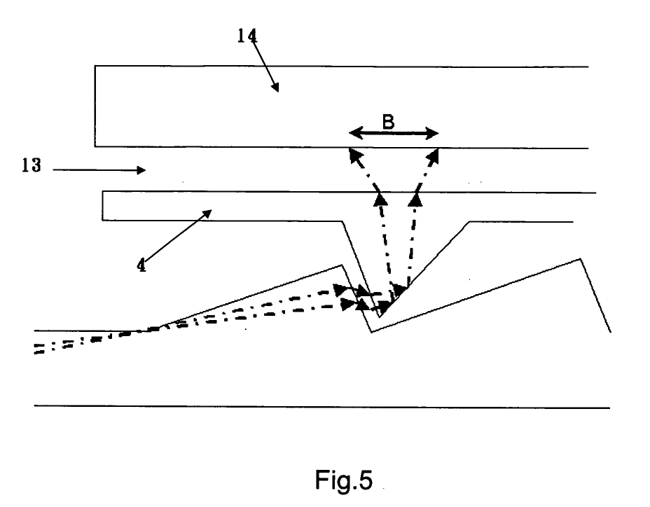

FIG. 6 illustrates effect on light beam width when reaching LCD substrate with film having similar refractive index of upper prism 3.

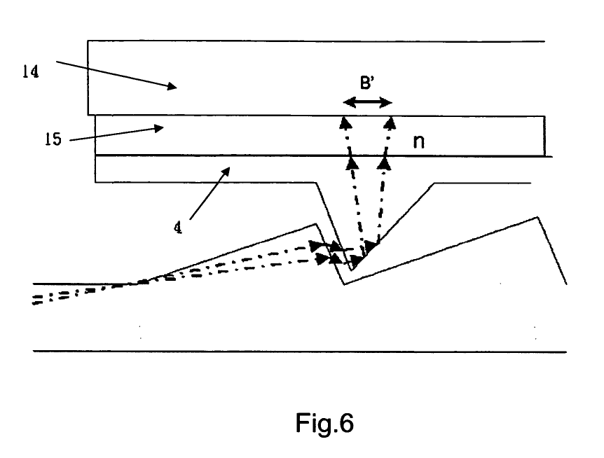

FIG. 7 illustrates parameters involved in embodiments of the present invention.

FIG. 8 illustrates representative drawing of “light guiding plate having multi-focused reflecting patterns” of TAIWAN PATENT published No. 463957.

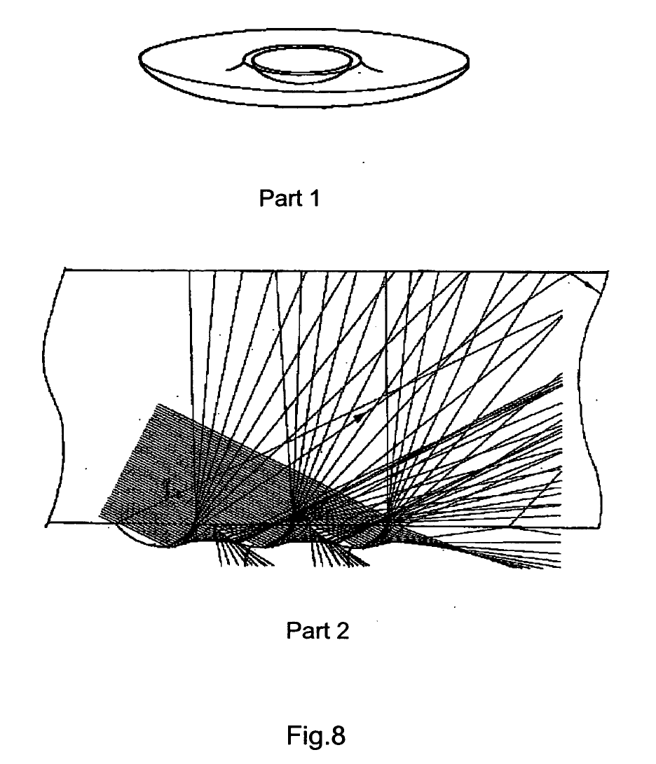

FIG. 9 illustrates the first representative drawing of “plane-type light source” of TAIWAN PATENT published No. 538285.

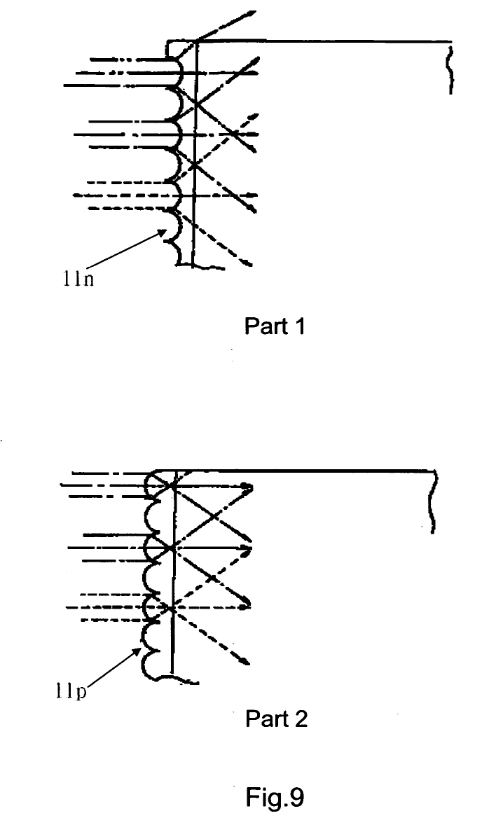

FIG. 10 illustrates the second representative drawing of “plane-type light source” of TAIWAN PATENT published No. 538285.

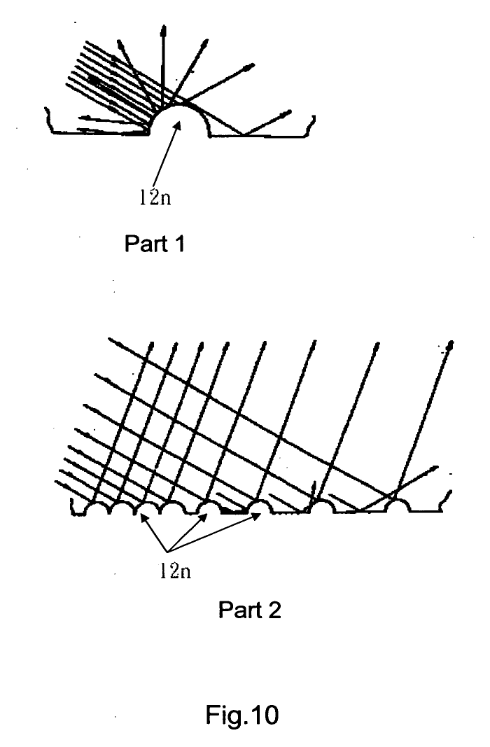

FIG. 11 illustrates the third representative drawing of “plane-type light source” of TAIWAN PATENT published No. 538285.

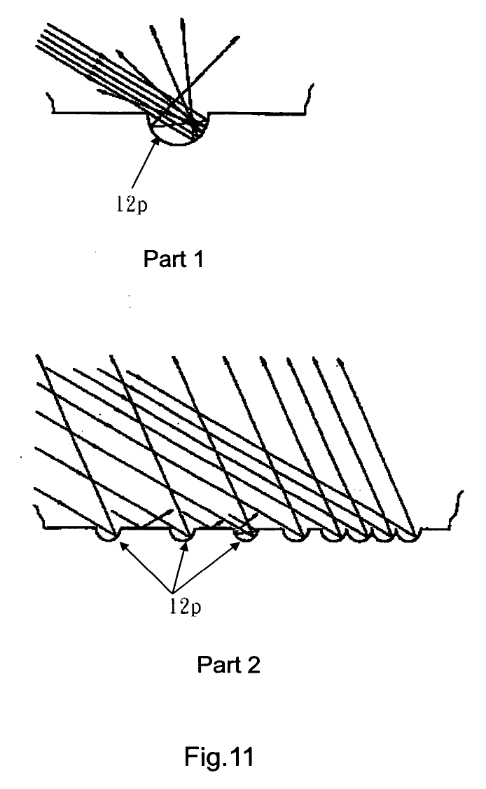

FIG. 12 illustrates representative drawing of “LCD having localized-light-transmitting backlight” of TAIWAN PATENT published No. 560621.

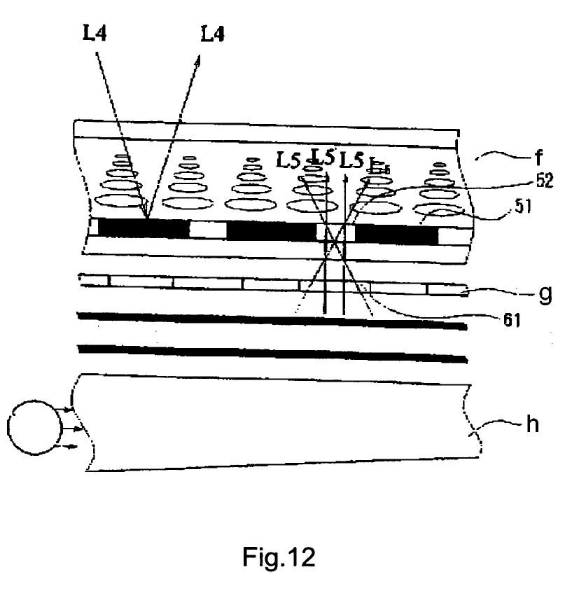

### LIST OF REFERENCE NUMERALS

1 lower prism
2 LGP light guiding plate
3 upper prism
4 upper prism plate
5 opening of LCD substrate
6 air gap
7 emitting face of lower prism 1
8 entering face of upper prism 3
9 total reflecting face of upper prism 3
10 interface between lower prism 1 and light guiding plate i.e. bottom side of lower prism 1 quasi-triangle
11 normal of total reflecting face of upper prism 3
12 interface between upper prism 3 and upper prism plate 4 i.e. opposite side of upper prism 3 quasi-triangle's vertex, which nearing light guiding plate
13 air layer
14 LCD liquid crystal display
15 film or filling refractive index of which similar to upper prism plate
16 border of two neighboring lower prisms
L distance of two neighboring openings of lcd substrate
ω opposite angle of emitting face of lower prism
α angle formed by emitting face 7 and bottom 10 of lower prism 1
θ upper prism quasi-triangle's vertex angle which nearing light guiding plate
θ_{c} critical angle of material of lower prism or upper prism
θ₁ angle formed by light beam and normal 11 of total reflecting 9
r₁ curvature radius of entering face 8 of upper prism 3
r₂ curvature radius of total reflecting face 9 of upper prism 3
t the shortest distance between LCD reflecting layer and intersecting point of entering (incident) face of upper prism 3 and total reflecting face of upper prism 3
A light beam width inside lower prism 1
A′ light beam width when leaving upper prism 3
B light beam width when reaching LCD substrate without film having similar refractive index of upper prism 3
B′ light beam width when reaching LCD substrate with film having similar refractive index of upper prism 3

### DETAILED DESCRIPTION OF PREFERRED EMBODIMENT OF THE PRESENT INVENTION

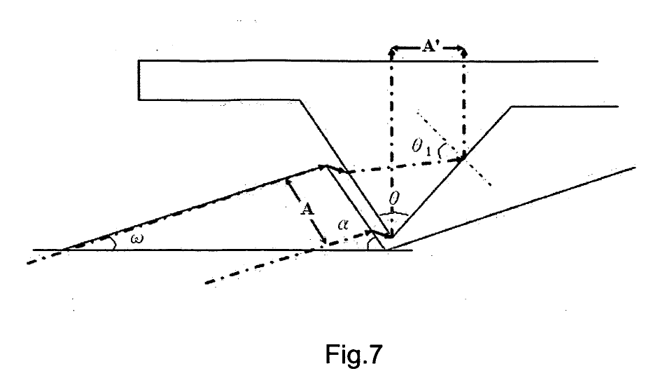

Two embodiments of “small-angled, specifically-positioned and specifically-orientated light emitting device of backlight module of liquid crystal display” of the present invention are described with reference to FIG. 7 and Table.1. Those specified numeric values proposed in each embodiment are only some part of the present invention, and the range of the present invention is not limited to those.

TABLE 1

| embod- | parameter value | | | | | | result |
|---|---|---|---|---|---|---|---|
| iment | ω | α | θ | θ₁ | A | A′ | orientation |
| 1 | 10° | 50° | 80° | 50° | ≈0.035 mm | ≈0.03 mm | ≈90° |
| 2 | 21.1° | 50° | 74.5° | 55.6° | ≈0.074 mm | ≈0.07 mm | ≈90° |

As shown in Table.1, within the range of parameters proposed by the present invention, i.e.:
0<ω≦0.5θ_{c}, (1 )
0<α≦90°, (2)
90°-θ_{c}≦θ≦180°-α-ω (3)
T<r₁≦∞, (4)
T<r₂≦∞, (5)

incorporated with relationships of concerned elements and parts, proposed by the present invention, in which both lower prism and upper prism are related to LGP, upper prism plate, openings of LCD substrate, and reflecting layer of LCD, the aim of the present invention: backlight module emitting light beams, from specified positions, limited to small angle range, and pointing to openings of LCD substrate, is accomplished certainly.

The focus of the present invention are that backlight module emits light beams, from specified positions, limited to small angle range, and pointing to openings of LCD substrate, and that the light beam optical process has the said characteristic, and that lower prism and upper prism within said parameters range have said relationships proposed by the present invention with LGP, upper prism plate, openings of LCD substrate, and reflective layer of LCD.

Any individual numeric value derived from spirit of the present invention by logical reasoning, mathematic calculation, or computer simulation, and any equivalent variation or modification are to be within claims range of the present invention. The embodiments mentioned above are only a portion of the present invention, the claims range of the present invention are not to be limited to those embodiments.

1. A small-angled, specifically-positioned and specifically-orientated light emitting device of backlight module of liquid crystal display,
characterized in that the said LCD backlight module emits light beams, from specified positions, limited to small angle range, and pointing to specified orientation,
including:
lower prism, comprising an emitting face, making light beams propagating in certain angles range inside LGP transmit through its emitting face of lower prism;
light guiding plate (LGP), engaged with a plurality of lower prisms into an integral unit on its emitting surface; or produced together, with a plurality of lower prisms located on its emitting surface, in an unit process;
upper prism, comprising an entering face and an total reflecting face, making light beams transmitting into its entering face be reflected totally from its total reflecting face and transmit through upper prism plate in certain specified orientations
upper prism plate, engaged with a plurality of upper prisms into an integral unit; or produced together with a plurality of upper prisms in an unit process;
wherein light beams propagating in certain angles range inside LGP are refracted by each corresponding said lower prism and transmit through said emitting face of each said lower prism, and across an air gap; said light beams are incident on, refracted by and transmit into said entering face of corresponding upper prism; said light beams propagate inside said upper prism and onto said total reflecting face, and then said light beams are totally reflected from said total reflecting face, and further said totally reflected light beams transmit through said upper prism plate, limited to small angle range, pointing to specified orientations, being able to be looked as if those were emitted from corresponding specified positions of LGP.

2. The small-angled, specifically-positioned and specifically-orientated light emitting device of backlight module of liquid crystal display according to claim 1, wherein the cross section of said lower prism is quasi-triangle.

3. The small-angled, specifically-positioned and specifically-orientated light emitting device of backlight module of liquid crystal display according to claim 1, wherein the cross section of said upper prism is quasi-triangle.

4. The small-angled, specifically-positioned and specifically-orientated light emitting device of backlight module of liquid crystal display according to claim 1, wherein said totally reflected light beams transmitting through said upper prism plate can be looked as if those were emitted from nearby of border of corresponding lower prisms of LGP.

5. The small-angled, specifically-positioned and specifically-orientated light emitting device of backlight module of liquid crystal display according to claim 2, wherein the cross section of said upper prism is quasi-triangle, and said totally reflected light beams transmitting through said upper prism plate can be looked as if those were emitted from nearby of border of corresponding lower prisms of LGP.

6. The small-angled, specifically-positioned and specifically-orientated light emitting device of backlight module of liquid crystal display according to claim 5, wherein the length of bottom side of lower prism's quasi-triangle which contacting LGP is near the distance of openings of LCD substrate.

7. The small-angled, specifically-positioned and specifically-orientated light emitting device of backlight module of liquid crystal display according to claim 5, wherein said totally reflected light beams transmitting through said upper prism plate are limited to small angle range; orientations of said small angle include those pointing to openings of LCD substrate.

8. The small-angled, specifically-positioned and specifically-orientated light emitting device of backlight module of liquid crystal display according to claim 5, wherein said totally reflected light beams transmitting through said upper prism plate are limited to small angle range; orientations of said small angle range include those vertical to said upper prism plate.

9. The small-angled, specifically-positioned and specifically-orientated light emitting device of backlight module of liquid crystal display according to claim 5, wherein lines drawn from borders of lower prisms and vertical to upper prism plate pass through openings of LCD substrate.

10. The small-angled, specifically-positioned and specifically-orientated light emitting device of backlight module of liquid crystal display according to claim 5, wherein, after the light beams transmit through said emitting face of each said lower prism and across air gap, said light beams are incident on, refracted by and transmit into said entering face of corresponding upper prism, and the angles, formed by normal of total reflecting face of upper prism and rays of said light beams propagating inside upper prism and onto total reflecting face, are equal to or greater than critical angle of upper prism material.

11. The small-angled, specifically-positioned and specifically-orientated light emitting device of backlight module of liquid crystal display according to claim 5, wherein, after transmitting into upper prism, light beams are totally reflected by total reflecting face of upper prism, then transmit through upper prism plate; the width of said light beams transmitting through upper prism plate is near width of said light beams when propagating inside lower prism, and directions of angle range of said light beams transmitting through upper prism plate include orientation vertical to upper prism plate.

12. The small-angled, specifically-positioned and specifically-orientated light emitting device of backlight module of liquid crystal display according to claim 5, wherein range of opposite angle ω of lower prism's emitting face is:
0<ω≦0.5θ_{c};
θ_{c} is critical angle of lower prism's material.

13. The small-angled, specifically-positioned and specifically-orientated light emitting device of backlight module of liquid crystal display according to claim 5, wherein range of angle α formed by emitting face and bottom side of lower prism is:
0<α≦90°.

14. The small-angled, specifically-positioned and specifically-orientated light emitting device of backlight module of liquid crystal display according to claim 5, wherein range of vertex angle θ of upper prism's quasi-triangle, which is near LGP, is:
90°-θ_{c}≦θ≦180°-α-ω;
θ_{c} is critical angle of lower prism's material; α is angle formed by emitting face and bottom side of lower prism, and ω is opposite angle of lower prism's emitting face.

15. The small-angled, specifically-positioned and specifically-orientated light emitting device of backlight module of liquid crystal display according to claim 5, wherein range of curvature radius of upper prism's entering face r₁ is:
T<r₁≦∞, and
range of curvature radius of upper prism's total reflecting face is:
T<r₂≦∞;
said T is the shortest distance between LCD substrate and intersecting point of entering face of upper prism and total reflecting face of upper prism.

16. The small-angled, specifically-positioned and specifically-orientated light emitting device of backlight module of liquid crystal display according to claim 5, wherein curvature center of entering face and total reflecting face of upper prism are above the border between upper prism and upper prism plate (i.e. opposite side of vertex angle θ of upper prism's quasi-triangle, which is near LGP).

17. The small-angled, specifically-positioned and specifically-orientated light emitting device of backlight module of liquid crystal display according to claim 5, wherein
the length of bottom side of quasi-triangle of lower prism (i.e. border line between each lower prism and LGP) is near distance of neighboring openings of LCD substrate, and
lines, which are drawn from borders of each two neighboring lower prisms and vertical to upper prism plate, will transmit through corresponding openings of LCD substrate.

18. The small-angled, specifically-positioned and specifically-orientated light emitting device of backlight module of liquid crystal display according to claim 5, wherein
the angles, formed by normal of total reflecting face of upper prism and rays of said light beams propagating inside upper prism and onto total reflecting face, are equal to or greater than critical angle of upper prism material, and
the width of said light beams transmitting through upper prism plate is near width of said light beams when propagating inside lower prism, and
directions of angle range of said light beams transmitting through upper prism plate include orientation vertical to upper prism plate.

19. The small-angled, specifically-positioned and specifically-orientated light emitting device of backlight module of liquid crystal display according to claim 5, wherein range of opposite angle ω of lower prism's emitting face is:
0<ω≦0.5θ_{c}, and
θ_{c} is critical angle of lower prism's material;
range of vertex angle θ of upper prism's quasi-triangle, which is near LGP, is:
90°-θ_{c}≦θ≦180°-α-ω, and
θ_{c} is critical angle of lower prism's material; α is angle formed by emitting face and bottom side of lower prism, and ω is opposite angle of lower prism's emitting face.

20. The small-angled, specifically-positioned and specifically-orientated light emitting device of backlight module of liquid crystal display according to claim 19, wherein
the length of bottom side of quasi-triangle of lower prism (i.e. border line between each lower prism and LGP) is near distance of neighboring openings of LCD substrate;
lines, which are drawn from borders of each two neighboring lower prisms and vertical to upper prism plate, will transmit through corresponding openings of LCD substrate;
the width of said light beams transmitting through upper prism plate is near width of said light beams when propagating inside lower prism, and
directions of angle range of said light beams transmitting through upper prism plate include orientation vertical to upper prism plate.

21. The small-angled, specifically-positioned and specifically-orientated light emitting device of backlight module of liquid crystal display according to claim 20, wherein range of curvature radius of upper prism's entering face r₁ is:
T<r₁≦∞, and
range of curvature radius of upper prism's total reflecting face is:
T<r₂≦∞;
said T is the shortest distance between LCD reflecting layer and intersecting point of entering face of upper prism and total reflecting face of upper prism.

22. The small-angled, specifically-positioned and specifically-orientated light emitting device of backlight module of liquid crystal display according to claim 21, wherein curvature center of entering face and total reflecting face of upper prism are above the border between upper prism and upper prism plate (i.e. opposite side of vertex angle θ of upper prism's quasi-triangle, which is near LGP).

23. The small-angled, specifically-positioned and specifically-orientated light emitting device of backlight module of liquid crystal display according to each individual claim from claim 1, wherein a film or filling layer with similar refractive index of upper prism is applied between upper prism plate and LCD's substrate.

24. The small-angled, specifically-positioned and specifically-orientated light emitting device of backlight module of liquid crystal display according to each individual claim from claim 2, wherein a film or filling layer with similar refractive index of upper prism is applied between upper prism plate and LCD's substrate.

25. The small-angled, specifically-positioned and specifically-orientated light emitting device of backlight module of liquid crystal display according to each individual claim from claim 3, wherein a film or filling layer with similar refractive index of upper prism is applied between upper prism plate and LCD's substrate.

26. The small-angled, specifically-positioned and specifically-orientated light emitting device of backlight module of liquid crystal display according to each individual claim from claim 4, wherein a film or filling layer with similar refractive index of upper prism is applied between upper prism plate and LCD's substrate.

27. The small-angled, specifically-positioned and specifically-orientated light emitting device of backlight module of liquid crystal display according to each individual claim from claim 5, wherein a film or filling layer with similar refractive index of upper prism is applied between upper prism plate and LCD's substrate.

28. The small-angled, specifically-positioned and specifically-orientated light emitting device of backlight module of liquid crystal display according to each individual claim from claim 6, wherein a film or filling layer with similar refractive index of upper prism is applied between upper prism plate and LCD's substrate.

29. The small-angled, specifically-positioned and specifically-orientated light emitting device of backlight module of liquid crystal display according to each individual claim from claim 7, wherein a film or filling layer with similar refractive index of upper prism is applied between upper prism plate and LCD's substrate.

30. The small-angled, specifically-positioned and specifically-orientated light emitting device of backlight module of liquid crystal display according to each individual claim from claim 8, wherein a film or filling layer with similar refractive index of upper prism is applied between upper prism plate and LCD's substrate.

31. The small-angled, specifically-positioned and specifically-orientated light emitting device of backlight module of liquid crystal display according to each individual claim from claim 9, wherein a film or filling layer with similar refractive index of upper prism is applied between upper prism plate and LCD's substrate.

32. The small-angled, specifically-positioned and specifically-orientated light emitting device of backlight module of liquid crystal display according to each individual claim from claim 10, wherein a film or filling layer with similar refractive index of upper prism is applied between upper prism plate and LCD's substrate.

33. The small-angled, specifically-positioned and specifically-orientated light emitting device of backlight module of liquid crystal display according to each individual claim from claim 11, wherein a film or filling layer with similar refractive index of upper prism is applied between upper prism plate and LCD's substrate.

34. The small-angled, specifically-positioned and specifically-orientated light emitting device of backlight module of liquid crystal display according to each individual claim from claim 12, wherein a film or filling layer with similar refractive index of upper prism is applied between upper prism plate and LCD's substrate.

35. The small-angled, specifically-positioned and specifically-orientated light emitting device of backlight module of liquid crystal display according to each individual claim from claim 13, wherein a film or filling layer with similar refractive index of upper prism is applied between upper prism plate and LCD's substrate.

36. The small-angled, specifically-positioned and specifically-orientated light emitting device of backlight module of liquid crystal display according to each individual claim from claim 14, wherein a film or filling layer with similar refractive index of upper prism is applied between upper prism plate and LCD's substrate.

37. The small-angled, specifically-positioned and specifically-orientated light emitting device of backlight module of liquid crystal display according to each individual claim from claim 15, wherein a film or filling layer with similar refractive index of upper prism is applied between upper prism plate and LCD's substrate.

38. The small-angled, specifically-positioned and specifically-orientated light emitting device of backlight module of liquid crystal display according to each individual claim from claim 16, wherein a film or filling layer with similar refractive index of upper prism is applied between upper prism plate and LCD's substrate.

39. The small-angled, specifically-positioned and specifically-orientated light emitting device of backlight module of liquid crystal display according to each individual claim from claim 17, wherein a film or filling layer with similar refractive index of upper prism is applied between upper prism plate and LCD's substrate.

40. The small-angled, specifically-positioned and specifically-orientated light emitting device of backlight module of liquid crystal display according to each individual claim from claim 18, wherein a film or filling layer with similar refractive index of upper prism is applied between upper prism plate and LCD's substrate.

41. The small-angled, specifically-positioned and specifically-orientated light emitting device of backlight module of liquid crystal display according to each individual claim from claim 19, wherein a film or filling layer with similar refractive index of upper prism is applied between upper prism plate and LCD's substrate.

42. The small-angled, specifically-positioned and specifically-orientated light emitting device of backlight module of liquid crystal display according to each individual claim from claim 20, wherein a film or filling layer with similar refractive index of upper prism is applied between upper prism plate and LCD's substrate.

43. The small-angled, specifically-positioned and specifically-orientated light emitting device of backlight module of liquid crystal display according to each individual claim from claim 21, wherein a film or filling layer with similar refractive index of upper prism is applied between upper prism plate and LCD's substrate.

44. The small-angled, specifically-positioned and specifically-orientated light emitting device of backlight module of liquid crystal display according to each individual claim from claim 22, wherein a film or filling layer with similar refractive index of upper prism is applied between upper prism plate and LCD's substrate.
